(19) United States
(12) Patent Application Publication
(10) Pub. No.: US 2024/0232083 A1
(43) Pub. Date: Jul. 11, 2024

(54) PARTITIONING A CACHE FOR APPLICATION OF A REPLACEMENT POLICY

(71) Applicant: SiFive, Inc., San Mateo, CA (US)

(72) Inventors: Wesley Waylon Terpstra, San Mateo, CA (US); Richard Van, San Jose, CA (US); Chao Wei Huang, Hsinchu (TW); Kevin Heuer, Marietta, GA (US)

(21) Appl. No.: 18/406,128

(22) Filed: Jan. 6, 2024

Related U.S. Application Data
(60) Provisional application No. 63/437,628, filed on Jan. 6, 2023.

(51) Int. Cl. G06F 12/0811; G06F 12/123

(52) U.S. Cl. CPC G06F 12/0811; G06F 12/123

(57) ABSTRACT

Systems and methods are disclosed for partitioning a cache for application of a replacement policy. For example, some methods may include partitioning entries of a set in a cache into two or more subsets; receiving a message that will cause a cache block replacement; responsive to the message, selecting a way of the cache by applying a replacement policy to entries of the cache from only a first subset of the two or more subsets; and responsive to the message, evicting an entry of the cache in the first subset and in the selected way.

### CROSS-REFERENCE TO RELATED APPLICATION(S)

This application claims priority to and the benefit of U.S. Provisional Patent Application Ser. No. 63/437,628, filed Jan. 6, 2023, the entire disclosure of which is hereby incorporated by reference.

### TECHNICAL FIELD

This disclosure relates to partitioning a cache for application of a replacement policy.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an integrated circuit for partitioning a cache for application of a replacement policy.

FIG. 2 is a flowchart of an example of a process for partitioning a cache for application of a replacement policy.

FIG. 3 is a flowchart of an example of a process for aging entries only in a subset of a cache in accordance with a replacement policy.

FIG. 4 is a flowchart of an example of a process for insertion a new cache line in a cache that is subject to a partition.

FIG. 5 is a flowchart of an example of a process for partitioning entries in a cache based on whether the cache lines stored in the entries are also stored by an inner cache.

FIG. 6 is a block diagram of an example of a system for facilitating generation and manufacture of integrated circuits.

FIG. 7 is a block diagram of an example of a system for facilitating generation of integrated circuits.

### DETAILED DESCRIPTION

Disclosed herein are implementations of partitioning a cache for application of a replacement policy. Some implementations may efficiently manage data storage in a cache by prioritizing certain subsets of the entries (e.g., entries storing data that is also stored by an inner cache) when applying a replacement policy to choose an entry as a victim when space needs to be freed up in the cache.

The latency of memory access becomes more important in modern microprocessor design. Increasing cache capacity with a hierarchy of different cache sizes is one of the ideas to reduce latency and to improve cache hit rate. But increasing cache size comes with the expense of longer latency, bigger area and more power consumption. Another solution to this difficult issue is to optimize the replacement algorithm to correctly predict the re-reference of the cache block in the future. Correct prediction can avoid the cache line being evicted to memory and being brought back from memory when it's needed again in a short period of time.

Some implementations described herein use new Inclusivity-Aware Static Re-Reference Interval Prediction (IA-SRRIP), which is based on Re-Reference Interval Prediction (RRIP). RRIP may not work well with non-inclusive cache due to its lack of inner cache presence information. By making replacement policy aware of data presence of the inner cache (or other properties), the replacement decisions can be optimized with knowledge of cache line data status. IA-SRRIP may work well with both non-inclusive and inclusive caches. IA-SRRIP may also be thrash-resistant by preserving some working sets using data inclusivity status.

There are many different implementations for a cache design. Way-associativity is one commonly used to reduce the conflict miss in a cache. Increasing the number of ways in a cache can improve the hit rate of a cache. An important topic deployed in this field is the replacement policy, that is, when we are going to allocate a new cache line in the cache and there is not enough space for it, some block has to be selected as a victim to be written back to the outer memory to free the space for the new block to allocate. This operation is also called eviction. Which block is to be written back is selected according to the replacement policies. If the evicted block is not used in the near future, it will not cause lost performance. On the other hand, if the evicted block is required in the near future, it would cause another cache miss and reduce performance.

Many of the popular replacement policies use the concept of “aging” for the re-reference interval prediction. At first, all ways are set with the same age, and set with a moderate level of age when a block is newly allocated. On a cache hit, the hit block may be set as youngest. When there's a cache miss, all the ways may be aged. When deciding which cache line is going to be evicted out from the cache for a new block, the ages would be the inputs for the decision. That is, to predict which way is the most unlikely to be used in the near future.

Such a replacement policy is most effective when all the attributes for the memory addresses are the same, since the costs for writing them out or filling them in again are quite similar. Aging all ways at the same time when there's a cache miss is reasonable. However, it might not be ideal for the cache system to require that all the memory attributes are equal. The relative ages for cache lines with different attributes are not always meaningful. Aging all the ways on a cache miss, might sometimes lead to bad victim prediction and lead to bad performance.

Some implementations described herein use another method for the aging in the replacement policies. First, group the cache lines into subgroups according to certain attributes. When allocating a cache line into the cache, the group attribute of the block may be recorded into tag ram. The group attribute for a given cache line may change over time. On a cache hit: update the age information according a replacement policy, as usual. On a cache miss, for a given request: prioritize the subgroups according to which should be replaced first by that request; choose the first non-empty subgroup to victimize according to the priority, and only age the ways of the cache line within the selected subgroup.

### Algorithm:

### Operation Defines:

Insertion operation: The operation the selected replacement policy would do when allocating a new cache line with a moderate age.

Promotion operation: The operation the selected replacement policy would do to increase the confidence of re-reference by reducing age.

Aging operation: The operation the selected replacement policy would do to decrease the confidence of re-reference by increasing the age.

Eviction point: The age a cache line reaches that corresponds to an eviction criteria.

For example, the algorithm may proceed as follows:

1. Cache lines in the cache ram may be categorized into N subgroups according to certain attributes. Note that a cache line should be in exactly one of the subgroups.

2. When the new request is a cache hit
a. Do the promotion operation

3. When the new request is a cache miss
a. Prioritize the subgroups from most desirable to replace G[0] to least G[N-1]
b. If there are available ways, select one among them. go to step 3.i
c. i=0
d. If there's any way with cache line marked with G[i], set x=i, go to step 3.f
e. i++, goes to 3.d
f. Do aging operation for ways that contain cache lines in G[x] of the victim
g. If not any ways reach the eviction point, go to step 3.f
h. Choose one of the ways that reach the eviction point and evict out the cache line
i. Do the insertion policy for the new request.
j. Check which subgroup the new request is, store it in the tag RAM

Step 3.c to 3.e is to find a target subgroup. Step 3.f to 3.h is to perform the aging operation for the selected subgroup. Do not age other subgroups.

Table 1 below illustrates an example for a 4-way cache with 2-bit SRRIP replacement policy and using whether the inner cache has the copy (innerPresent, IP) as the attribute to separate cache lines into subgroups. The IP=0 is G[0], IP=1 is G[1]. Which means we are going to evict out cache line with inner-Present=false first. CL is cache line. RRPV is the Re-Reference Prediction Value in the SRRIP algorithm. A, B, C, D, E stands for different requests sent to the Cache.

TABLE 1
Example of Aging Subgroup SRRIP for 4-way cache

| | Next | way3 | | | way2 | | | way1 | | | way0 | | | |
|---|---|---|---|---|---|---|---|---|---|---|---|---|---|---|
| step | Ref | CL | IP | RRPV | CL | IP | RRPV | CL | IP | RRPV | CL | IP | RRPV | Result |
| 1 | A | — | — | 3 | — | — | 3 | — | — | 3 | — | — | 3 | miss |
| 2 | B | A | 1 | 2 | — | — | 3 | — | — | 3 | — | — | 3 | miss |
| 3 | C | A | 1 | 2 | B | 1 | 2 | — | — | 3 | — | — | 3 | miss |
| 4 | D | A | 1 | 2 | B | 1 | 2 | C | 1 | 2 | — | — | 3 | miss |
| 5 | C | A | 1 | 2 | B | 1 | 2 | C | 1 | 2 | D | 1 | 2 | hit |
| 6 | D | A | 1 | 2 | B | 1 | 2 | C | 1 | 0 | D | 1 | 2 | hit |
| 7 | — | A | 1 | 2 | B | 1 | 2 | C | 1 | 0 | D | 1 | 0 | — |
| 8 | — | A | 1 | 2 | B | 0 | 2 | C | 0 | 0 | D | 1 | 0 | — |
| 9 | E | A | 1 | 2 | B | 0 | 2 | C | 0 | 0 | D | 1 | 0 | miss |
| 9.a | — | A | 1 | 2 | B | 0 | 3 | C | 0 | 1 | D | 1 | 0 | — |
| 10 | — | A | 1 | 2 | E | 1 | 2 | C | 0 | 1 | D | 1 | 0 | — |

In step 7, the cache lines of B and C are removed from the inner caches due to some events such as inner cache eviction. So, in step 8, the IP for way 2 and way 3 become 0. In step 9, since there are some ways containing IP=0, that is way 2 and way 1, and E is a cache miss, we only age way 2 and way 1. The step 9.a shows the aging result. In step 10, finally select way 2 to allocate E.

To further fine-tune and improve this algorithm, workloads with thrashing, scanning and mixed access patterns can be run and resulting hit/miss rate may be measured.

In some implementations, inner cache eviction insertion values may be kept the same. Keeping the same inner eviction RRPV can help with thrashing access patterns when workload size is bigger than inner cache size.

Some implementations may provide advantages over conventional cache architectures, such as, for example, supporting multiple cache inclusivity schemes (e.g., both non-inclusive and inclusive); improving thrash-resistance of a cache by preserving some working sets using cache inclusivity status; and/or increasing the speed/performance of a memory system in an SoC in some conditions.

As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

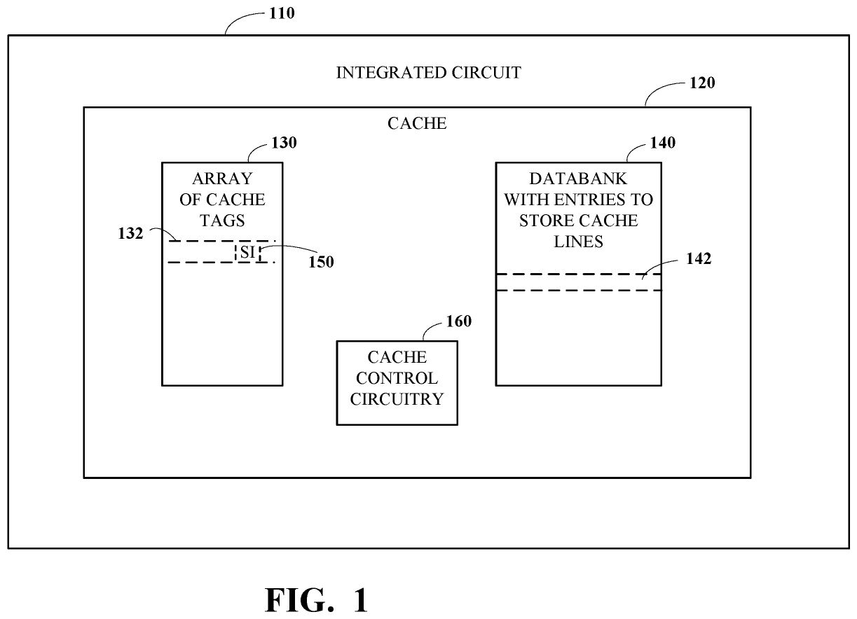

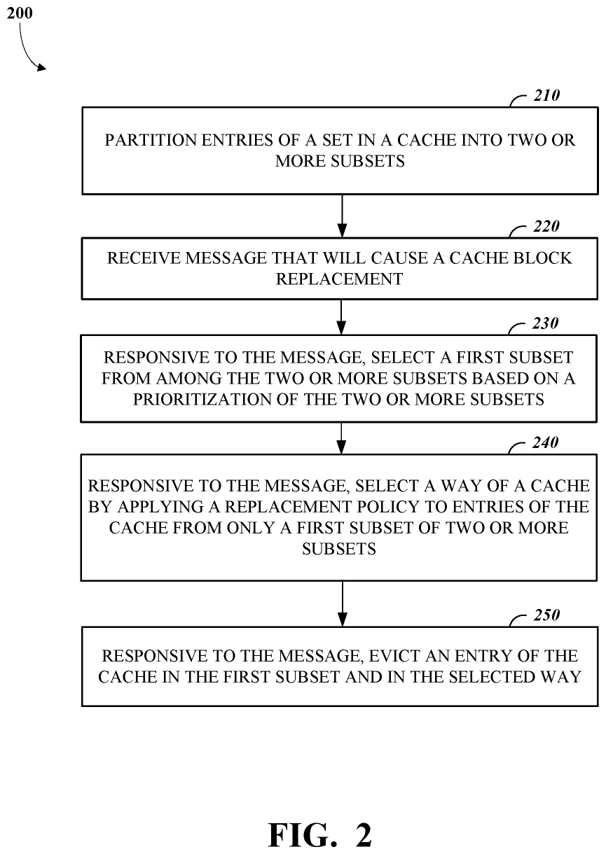

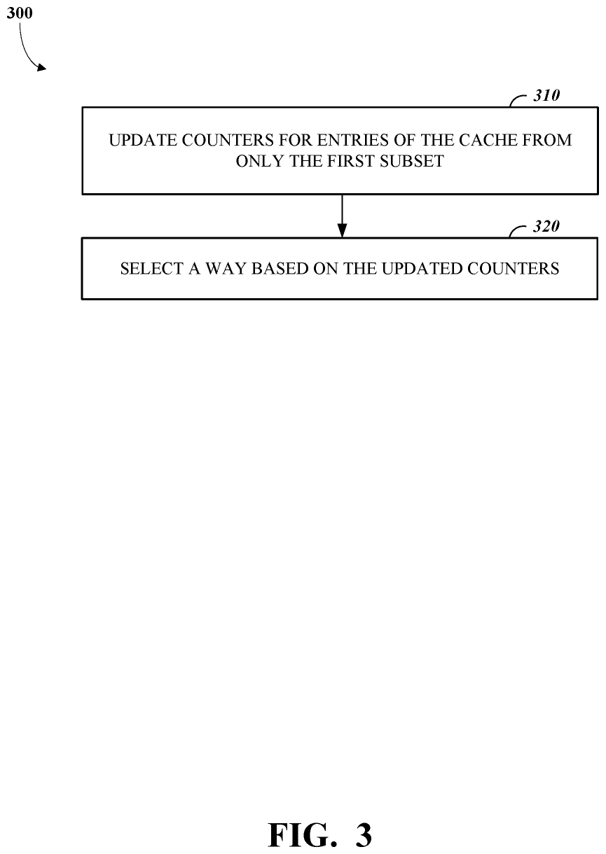

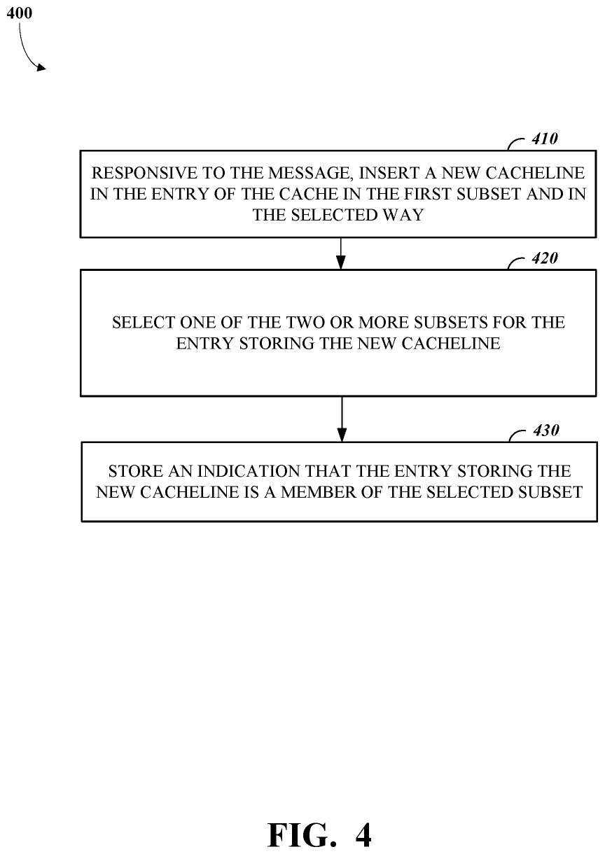

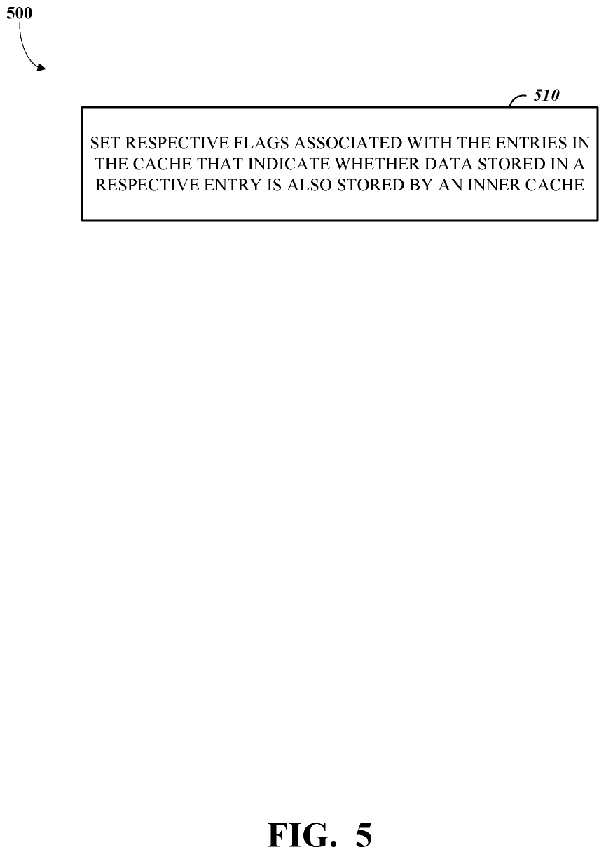

FIG. 1 is a block diagram of an example of an integrated circuit 110 for partitioning a cache for application of a replacement policy. The integrated circuit 110 (e.g., a system on a chip (SOC)) includes a cache 120. The cache 120 includes a databank 140 with multiple entries (see, e.g., entry 142) configured to store respective cache lines; an array of cache tags 130 (see, e.g., cache tag 132) associated with respective entries in the databank, wherein each cache tag includes an indication (see, e.g., subset indication 150) of which one of two or more subsets the respective entry is a member of; and a cache control circuitry 160 configured to apply a replacement policy to entries of the cache from only a first subset of the two or more subsets to select an entry of the cache in the first subset for eviction. For example, the integrated circuit 110 may be used to implement the process 200 of FIG. 2. For example, the integrated circuit 110 may be used to implement the process 300 of FIG. 3. For example, the integrated circuit 110 may be used to implement the process 400 of FIG. 4. For example, the integrated circuit 110 may be used to implement the process 500 of FIG. 5.

The cache 120 includes a databank 140 with multiple entries configured to store respective cache lines and an array of cache tags 130 associated with respective entries in the databank 140. The array of cache tags 130 may be associated with respective entries in the databank 140 in various ways. In some implementations, the array of cache tags 130 may be statically associated with respective entries in the databank 140. For example, a cache tag (e.g., the cache tag 132) in the array of cache tags 130 may be stored at an offset in the array of cache tags 130 that matches an offset at which its respective entry (e.g., entry 142) is stored in the databank 140. For example, a cache tag (e.g., the cache tag 132) in the array of cache tags 130 may be stored adjacent to its respective entry (e.g., entry 142) in a memory (e.g., a static random access memory (SRAM)) that stores both the array of cache tags 130 and the databank 140. In some implementations, the array of cache tags 130 may be dynamically associated with respective entries in the databank 140. For example, a cache tag (e.g., the cache tag 132) in the array of cache tags 130 may include a data pointer (e.g., an index to an entry in the databank 140) that points to its respective entry (e.g., the entry 142) in the databank 140. In some implementations, the databank 140 is one of multiple databanks and a cache tag stored in the array of cache tags 130 includes a bank identifier and an index for its respective entry in a databank corresponding to the bank identifier. Decoupling a cache tag from the memory used to store its associated cache line using a data pointer may enable the re-association of data to a physical address without the need to copy the data from temporary storage. It may also simplify the implementation of a non-inclusive cache, where data buffers are only associated to those addresses for which retaining a copy of the data improves performance. For example, the cache 120 may be configurable to vary in size (e.g., from 4 megabytes to 32 megabytes). For example, the cache 120 may be non-inclusive. In some implementations, the cache 120 may be physically indexed physically tagged (PIPT). In some implementations, the array of cache tags 130 may be organized into one or more ways. For example, the cache 120 may be 16-way set associative. An entry in the databank 140 may be configured to store a cache line of data. For example, a cache line size of the cache 120 may be 64 bytes. In some implementations, the cache 120 includes a directory cache to handle snoop filtering. For example, the array of cache tags 130 may include SRAM or flops for storing cache tags. For example, the cache 120 may support a modified owned exclusive shared invalid (MOESI) cache coherency protocol. In some implementations, the cache 120 supports butterfly or mesh network on a chip (NOC) topology. For example, the cache 120 may be configured to support error detect and reporting for reliability availability serviceability (RAS). In some implementations, the cache 120 includes performance monitors.

Each cache tag includes an indication (e.g., the subset indication 150) of which one of two or more subsets the respective entry is a member of. For example, the subset indication 150 may include innerPresent (IP) flag or bit (as described above in relation to Table 1), which indicates whether an inner cache currently stores a copy of the cache line stored in the respective entry 142 of the cache tag 132. In some implementations, the subset indication 150 includes multiple flags or bits indicating various attributes of a cache line that may be used to partition the set of cache lines stored in the cache 120 into multiple subsets. For example, the subset indication 150 may include an IP flag and an outer cache status field, which indicates whether an outer cache is currently storing a copy of the data associated with the cache tag. For example, the subset indication 150 may include a flag that indicates whether the entry is dirty or clean. For example, the subset indication 150 may include a field that indicates whether there is no data buffer currently associated with the cache tag (i.e., the entry is in a state that is valid but without data). For example, the subset indication 150 may include a field that indicates whether the cache is inclusive of a client (e.g., an inner cache) associated with the entry.

The cache 120 includes a cache control circuitry 160. The cache control circuitry 160 may be configured to select an entry the cache 120 for eviction by applying a replacement policy to entries of the cache from only a first subset of the two or more subsets. The cache 120 may apply different cache replacement policies, such as, re-reference interval prediction (RRIP), pseudo-least recently used (pLRU), or random. For example, the cache control circuitry 160 may be configured to: receive a message that will cause a cache block replacement; responsive to the message, select a way of the cache 120 by applying a replacement policy to entries of the cache 120 from only a first subset of the two or more subsets; and, responsive to the message, evict an entry of the cache in the first subset and in the selected way. For example, the message may be a request to access (e.g., to read or to write) data stored at an address in memory (e.g., random access memory (RAM)). The request may result in a cache miss, which may require an entry in cache 120 to be evicted to make room for the acquisition of the requested data from an outer memory system including a memory controller and/or one or more outer caches in a cache hierarchy. For example, the message may be a request to obtain permissions for one or more entries in the cache 120 (i.e., without data to be read or written). For example, the message may be a resource prediction message that will trigger a prefetch of data via the cache 120. In some implementations, the cache control circuitry 160 is configured to, responsive to the message, select the first subset from among the two or more subsets based on a prioritization of the two or more subsets. For example, the cache control circuitry 160 may prioritize the eviction from a subset of entries that are for which a copy no longer is stored in an inner cache (e.g., because it has been evicted from an inner cache). For example, the cache control circuitry 160 may prioritize the eviction from a subset of entries corresponding to an inner cache that the cache 120 is inclusive of. For example, the cache control circuitry 160 may prioritize the eviction from a subset of entries corresponding to an inner cache that the cache 120 is non-inclusive (e.g., exclusive) of. For example, the cache control circuitry 160 may prioritize the eviction from a subset of entries corresponding to an outer cache that is inclusive of the cache 120. In some implementations, the cache control circuitry 160 is configured to set a flag (e.g., an IP flag, as described in relation to Table 1 above) in a cache tag associated with a respective entry in the cache 120 to indicate whether data stored in the respective entry is also stored by an inner cache.

The cache control circuitry 160 may be configured to implement an aging operation of a replacement policy (e.g., a SRRIP policy) to only one of the subsets of entries in the cache 120 when selecting an entry for eviction. For example, the cache control circuitry 160 may be configured to update counters for entries of the cache from only the first subset. In some implementations, the counters for entries of the cache 120 are age counters that are incremented to perform an aging operation of the replacement policy. In some implementations, the replacement policy is a Re-reference Interval Prediction policy and the counters for entries are respective re-reference prediction values for the entries (e.g., as described in relation to Table 1). The cache control circuitry 160 may be configured to implement an aging operation of a replacement policy to more than one, but less than all, of the subsets of entries in the cache 120 when selecting an entry for eviction. In some implementations, the cache control circuitry 160 may be configured to compare values of the counters for entries of the cache from the first subset; and break a tie between two entries from the first subset with a same counter value by selecting among ways with the tied entries using a round robin selection. In some implementations, the cache control circuitry 160 may be configured to compare values of the counters for entries of the cache from the first subset; and break a tie between two entries from the first subset with a same counter value by selecting among ways with the tied entries using a pseudo random selection (e.g., using a linear feedback shift register).

When adding a new cache line to an entry (e.g., the entry 142) in the cache 120 (e.g., when a cache miss has occurred), the cache control circuitry 160 may be configured to identify which subset of the two or more subsets the entry should be a member of, and to store an indication (e.g., the subset indication 150) of the identified subset in the cache tag (e.g., the cache tag 132) for the entry. For example, the cache control circuitry 160 may be configured to: responsive to the message, insert a new cache line in the entry of the cache in the first subset and in the selected way; select one of two or more subsets for the entry storing the new cache line; and store an indication that the entry storing the new cache line is a member of the selected subset. For example, the one of the two or more subsets may be selected based on properties of the new cache line and/or of the inner cache or other agent that was the source of the message.

In some implementations, the cache 120 may be a non-inclusive cache. In some implementations, the cache 120 may be an L2 cache that is private to one processor core. In some implementations, the cache 120 may be an L2 cache that is shared by multiple processor cores. In some implementations, the cache 120 may be an L3 cache that is shared by multiple processor cores.

FIG. 2 is a flowchart of an example of a process 200 for partitioning a cache for application of a replacement policy. The process 200 includes partitioning 210 entries of a set in a cache into two or more subsets; receiving 220 a message that will cause a cache block replacement; responsive to the message, selecting 230 the first subset from among the two or more subsets based on a prioritization of the two or more subsets; responsive to the message, selecting 240 a way of the cache by applying a replacement policy to entries of the cache from only a first subset of the two or more subsets; and, responsive to the message, evicting 250 an entry of the cache in the first subset and in the selected way. For example, the process 200 may be implemented using the integrated circuit 110 of FIG. 1.

The process 200 includes partitioning 210 entries of a set in a cache (e.g., the cache 120) into two or more subsets. For example, the entries in the cache may be partitioned 210 into subsets based on certain attributes of the cache lines stored in those entries and/or of the inner cache or other agent that was the source of a request for those cache lines. For example, a relevant attribute may be whether an inner cache currently stores a copy of the cache line stored in an entry of the cache, which may be recorded as an IP flag or bit (as described above in relation to Table 1) in a respective cache tag of the entry in the cache. In some implementations, multiple attributes of a cache line may be used to partition 210 the set of cache lines stored in the cache into multiple subsets. For example, a subset indication for an entry in the cache may include an IP flag and an outer cache status field, which indicates whether an outer cache is currently storing a copy of the data associated with the cache tag. In some implementations, the entries may be partitioned 210 as they are allocated. When allocating a cache line into the cache (e.g., when a cache miss has occurred), the relevant attributes of the cache line may be determined and used to select one of two or more subsets for the entry that will store the cache line. Partitioning 210 the entries may include recording respective indications of the selected subset for an entry into a respective cache tag for an entry. For example, the process 400 of FIG. 4 may be used to partition 210 the entries of the cache as they are allocated. The attributes for a given cache line may change over time and partitioning 210 the entries may include updating the indications of the subset stored in the cache tags when a relevant attribute changes. For example, one relevant attribute may be whether an inner cache currently stores a copy of the cache line stored in the respective entry, which may change when the cache line is evicted from the inner cache. In some implementations, partitioning 210 the entries may include setting respective flags associated with the entries in the cache that indicate whether data stored in a respective entry is also stored by an inner cache. For example, the process 500 of FIG. 5 may be used to partition 210 the entries of the cache as a relevant attribute of their respective cache lines change over time.

The process 200 includes receiving 220 a message that will cause a cache block replacement. For example, the message may be a request to access (e.g., to read or to write) data stored at an address in memory (e.g., random access memory (RAM)). For example, the address may be a physical address that can be used directly to access memory. In some implementations, the address may be a virtual address that must be translated to a physical address in order to access memory using the address. The request may result in a cache miss, which may require an entry in cache to be evicted to make room for the acquisition of the requested data from an outer memory system including a memory controller and/or one or more outer caches in a cache hierarchy. For example, the received 220 message may be a request to obtain permissions for one or more entries in the cache (i.e., without data to be read or written). For example, the received 220 message may be a resource prediction message that will trigger a prefetch of data via the cache. The subsets may be considered when applying a cache replacement policy to select an entry in the cache for eviction.

The process 200 includes, responsive to the message, selecting 230 a first subset from among the two or more subsets based on a prioritization of the two or more subsets. The first subset may be selected 230 for application of a cache replacement policy (e.g., an SRRIP replacement policy) to select an entry in the cache for eviction. For example, the prioritization may prioritize the eviction from a subset of entries that are for which a copy no longer is stored in an inner cache (e.g., because it has been evicted from an inner cache). For example, the prioritization may prioritize the eviction from a subset of entries corresponding to an inner cache that the cache 120 is inclusive of. For example, the prioritization may prioritize the eviction from a subset of entries corresponding to an inner cache that the cache is non-inclusive (e.g., exclusive) of. For example, the prioritization may prioritize the eviction from a subset of entries corresponding to an outer cache that is inclusive of the cache. For example, the prioritization may prioritize the eviction from a subset of entries that are dirty. For example, the prioritization may prioritize the eviction from a subset of entries for which there is no data buffer currently associated with the cache tag (i.e., the entry is in a state that is valid but without data). For example, the prioritization may prioritize the eviction from a subset of entries for which the cache is inclusive of a client (e.g., an inner cache) associated with the entry.

The process 200 includes, responsive to the message, selecting 240 a way of the cache by applying a replacement policy to entries of the cache from only the first subset of the two or more subsets. In some implementations, applying the replacement policy to entries of the cache from only the first subset includes updating counters for entries of the cache from only the first subset. For example, the counters for entries of the cache may be age counters that are incremented to perform an aging operation of the replacement policy. In some implementations, the replacement policy is a Re-reference Interval Prediction policy and the counters for entries are respective re-reference prediction values for the entries. For example, an entry with a highest age counter value from among the first subset of entries may be selected 240 for eviction. For example, selecting 240 a way of the cache for replacement may include implementing the process 300 of FIG. 3. In some implementations, selecting 240 a way of the cache for replacement may include applying an aging operation of a replacement policy to more than one, but less than all, of the subsets of entries in the cache. In some implementations, selecting 240 a way of the cache may include comparing values of the counters for entries of the cache from the first subset; and breaking a tie between two entries from the first subset with a same counter value by selecting among ways with the tied entries using a round robin selection. In some implementations, selecting 240 a way of the cache may include comparing values of the counters for entries of the cache from the first subset; and breaking a tie between two entries from the first subset with a same counter value by selecting among ways with the tied entries using a pseudo random selection (e.g., using a linear feedback shift register).

The process 200 includes, responsive to the message, evicting 250 an entry of the cache in the first subset and in the selected way. The evicted entry may then be reallocated to store a new cache line of data that was the subject of the message (e.g., a request for data). As the entry is reallocated, it may again be partitioned 210 into one of the subsets by storing an indication of its subset in the respective cache tag for the entry. For example, the process 400 of FIG. 4 may be implemented to reallocate the evicted entry.

FIG. 3 is a flowchart of an example of a process 300 for aging entries only in a subset of a cache in accordance with a replacement policy. The process 300 includes updating 310 counters for entries of the cache from only the first subset; and selecting 320 a way based on the updated counters. In some implementations, the counters for entries of the cache are age counters that are incremented to perform an aging operation of the replacement policy. In some implementations, the replacement policy is a Re-reference Interval Prediction policy and the counters for entries are respective re-reference prediction values for the entries. In some implementations, selecting 320 a way based on the updated counters may include comparing values of the counters for entries of the cache from the first subset; and breaking a tie between two entries from the first subset with a same counter value by selecting among ways with the tied entries using a round robin selection. In some implementations, selecting 320 a way based on the updated counters may include comparing values of the counters for entries of the cache from the first subset; and breaking a tie between two entries from the first subset with a same counter value by selecting among ways with the tied entries using a pseudo random selection (e.g., using a linear feedback shift register). For example, the process 300 may be implemented using the integrated circuit 110 of FIG. 1.

FIG. 4 is a flowchart of an example of a process 400 for insertion a new cache line in a cache that is subject to a partition. The process 400 includes, responsive to the message, inserting 410 a new cache line in the entry of the cache in the first subset and in the selected way; selecting 420 one of two or more subsets for the entry storing the new cache line; and storing 430 an indication that the entry storing the new cache line is a member of the selected subset. For example, the process 400 may be implemented using the integrated circuit 110 of FIG. 1.

The process 400 includes responsive to the message, inserting 410 a new cache line in the entry of the cache in the first subset and in the selected way. The entry that has recently been evicted may now be reallocated to store the new cache line of data. For example, this reallocation may follow from a cache miss caused by the message (e.g., a request for data). There may be significant and/or variable delay (e.g., due to delays reading from an outer memory system via one or more buses) between when the message is received by the cache and when the new cache line of data is inserted 410 in the entry of the cache. Nonetheless, the new cache line is inserted 410 responsive to the message in the sense that it is one of the operations performed in response to the message. The new cache line of data may also be forwarded to an agent in the cache hierarchy that sent the message (e.g., an inner cache or a processor core).

The process 400 includes selecting 420 one of two or more subsets for the entry storing the new cache line. For example, the subset for the entry may be selected 420 based on certain attributes of the new cache line and/or of the inner cache or other agent that was the source of the message that requested the new cache line. For example, a relevant attribute may be whether an inner cache currently stores a copy of the new cache line. In some implementations, multiple attributes of the new cache line may be used to select 420 the new subset for the entry.

The process 400 includes storing 430 an indication (e.g., the subset indication 150) that the entry storing the new cache line is a member of the selected subset. For example, the indication may be stored in a respective cache tag (e.g., the cache tag 132) for the entry. In some implementations, the indication may include an IP flag or bit (as described above in relation to Table 1). For example, the indication for the entry may include multiple attributes, such as, an IP flag and an outer cache status field, which indicates whether an outer cache is currently storing a copy of the new cache line.

FIG. 5 is a flowchart of an example of a process 500 for partitioning entries in a cache based on whether the cache lines stored in the entries are also stored by an inner cache. The process 500 includes setting 510 respective flags associated with the entries in the cache that indicate whether data stored in a respective entry is also stored by an inner cache. In some implementations, the respective flags may be IP flags (as described above in relation to Table 1). For example, a respective flag for an entry may need to be updated when the cache line of data that the entry stores is evicted from the inner cache. Maintaining a partition of the entries in the cache in this manner may enable eviction from the cache to be performed in an inclusivity-aware manner. For example, the process 500 may be implemented using the integrated circuit 110 of FIG. 1.

In some implementations, the entries in the cache may be partitioned based on other attributes and partitioning the entries may include updating other or additional fields in the respective cache tags for the entries to reflect a current status of these other attributes for the entries. For example, the entries in the cache may be partitioned based on whether the entry is dirty or clean and partitioning the entries may include updating a flag in a cache tag to reflect whether the corresponding entry is dirty. For example, the entries in the cache may be partitioned based on whether there is a data buffer currently associated with the cache tag for the entry and partitioning the entries may include updating a field in a cache tag to reflect whether the corresponding entry is in a state that is valid but without data. For example, the entries in the cache may be partitioned based on whether the cache is inclusive of a client (e.g., an inner cache) associated with the entry and partitioning the entries may include updating a flag in a cache tag to reflect whether the corresponding entry is associated with a client of which the cache is inclusive.

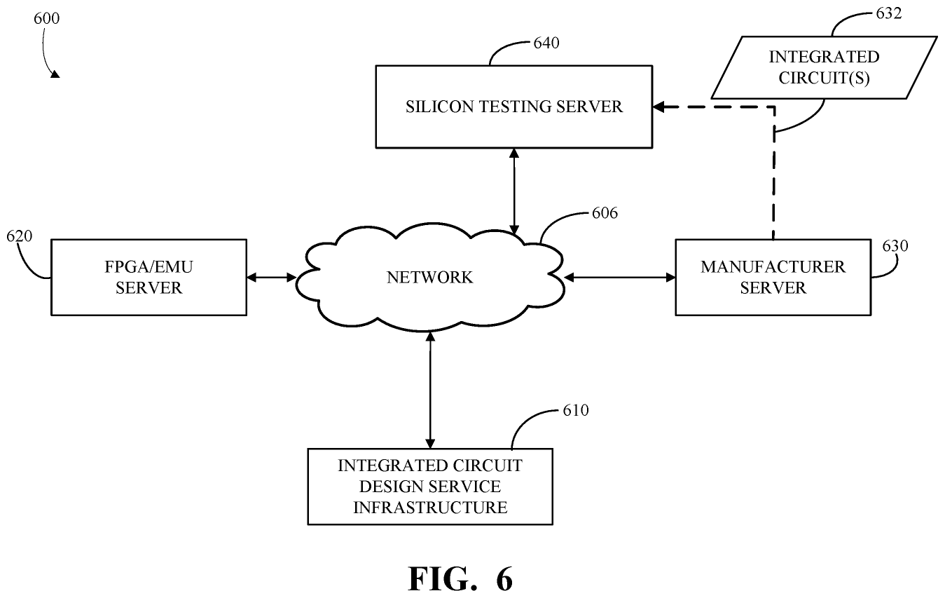

FIG. 6 is a block diagram of an example of a system 600 for generation and manufacture of integrated circuits. The system 600 includes a network 606, an integrated circuit design service infrastructure 610, a field programmable gate array (FPGA)/emulator server 620, and a manufacturer server 630. For example, a user may utilize a web client or a scripting API client to command the integrated circuit design service infrastructure 610 to automatically generate an integrated circuit design based a set of design parameter values selected by the user for one or more template integrated circuit designs. In some implementations, the integrated circuit design service infrastructure 610 may be configured to generate an integrated circuit design that includes the circuitry shown and described in FIG. 1.

The integrated circuit design service infrastructure 610 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high-level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 610 may invoke (e.g., via network communications over the network 606) testing of the resulting design that is performed by the FPGA/emulation server 620 that is running one or more FPGAs or other types of hardware or software emulators. For example, the integrated circuit design service infrastructure 610 may invoke a test using a field programmable gate array, programmed based on a field programmable gate array emulation data structure, to obtain an emulation result. The field programmable gate array may be operating on the FPGA/emulation server 620, which may be a cloud server. Test results may be returned by the FPGA/emulation server 620 to the integrated circuit design service infrastructure 610 and relayed in a useful format to the user (e.g., via a web client or a scripting API client).

The integrated circuit design service infrastructure 610 may also facilitate the manufacture of integrated circuits using the integrated circuit design in a manufacturing facility associated with the manufacturer server 630. In some implementations, a physical design specification (e.g., a graphic data system (GDS) file, such as a GDS II file) based on a physical design data structure for the integrated circuit is transmitted to the manufacturer server 630 to invoke manufacturing of the integrated circuit (e.g., using manufacturing equipment of the associated manufacturer). For example, the manufacturer server 630 may host a foundry tape out website that is configured to receive physical design specifications (e.g., as a GDSII file or an OASIS file) to schedule or otherwise facilitate fabrication of integrated circuits. In some implementations, the integrated circuit design service infrastructure 610 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 610 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 630 may fabricate and/or test integrated circuits based on the integrated circuit design. For example, the associated manufacturer (e.g., a foundry) may perform optical proximity correction (OPC) and similar post-tapeout/pre-production processing, fabricate the integrated circuit(s) 632, update the integrated circuit design service infrastructure 610 (e.g., via communications with a controller or a web application server) periodically or asynchronously on the status of the manufacturing process, perform appropriate testing (e.g., wafer testing), and send to packaging house for packaging. A packaging house may receive the finished wafers or dice from the manufacturer and test materials and update the integrated circuit design service infrastructure 610 on the status of the packaging and delivery process periodically or asynchronously. In some implementations, status updates may be relayed to the user when the user checks in using the web interface and/or the controller might email the user that updates are available.

In some implementations, the resulting integrated circuits 632 (e.g., physical chips) are delivered (e.g., via mail) to a silicon testing service provider associated with a silicon testing server 640. In some implementations, the resulting integrated circuits 632 (e.g., physical chips) are installed in a system controlled by silicon testing server 640 (e.g., a cloud server) making them quickly accessible to be run and tested remotely using network communications to control the operation of the integrated circuits 632. For example, a login to the silicon testing server 640 controlling a manufactured integrated circuits 632 may be sent to the integrated circuit design service infrastructure 610 and relayed to a user (e.g., via a web client). For example, the integrated circuit design service infrastructure 610 may control testing of one or more integrated circuits 632, which may be structured based on an RTL data structure.

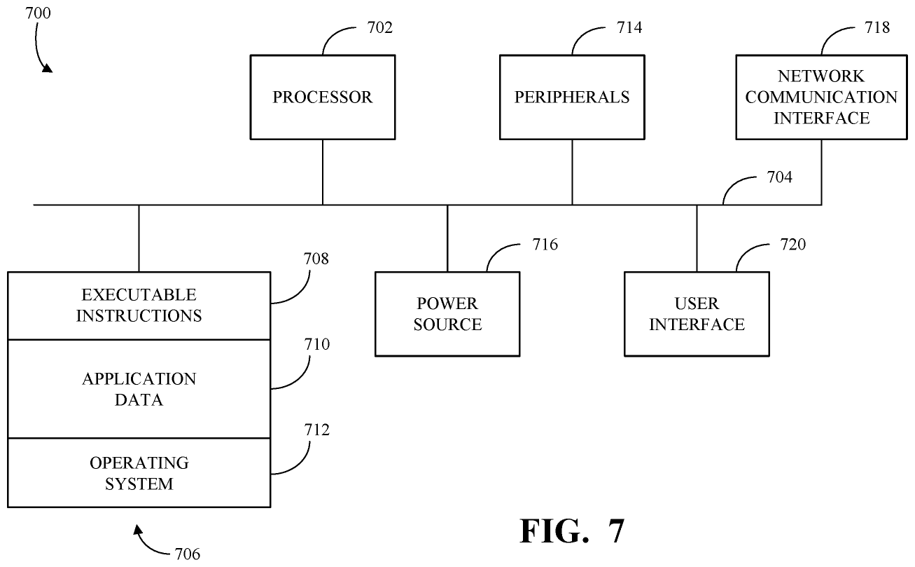

FIG. 7 is a block diagram of an example of a system 700 for facilitating generation of integrated circuits, for facilitating generation of a circuit representation for an integrated circuit, and/or for programming or manufacturing an integrated circuit. The system 700 is an example of an internal configuration of a computing device. The system 700 may be used to implement the integrated circuit design service infrastructure 610, and/or to generate a file that generates a circuit representation of an integrated circuit design including the circuitry shown and described in FIG. 1. The system 700 can include components or units, such as a processor 702, a bus 704, a memory 706, peripherals 714, a power source 716, a network communication interface 718, a user interface 720, other suitable components, or a combination thereof.

The processor 702 can be a central processing unit (CPU), such as a microprocessor, and can include single or multiple processors having single or multiple processing cores. Alternatively, the processor 702 can include another type of device, or multiple devices, now existing or hereafter developed, capable of manipulating or processing information. For example, the processor 702 can include multiple processors interconnected in any manner, including hardwired or networked, including wirelessly networked. In some implementations, the operations of the processor 702 can be distributed across multiple physical devices or units that can be coupled directly or across a local area or other suitable type of network. In some implementations, the processor 702 can include a cache, or cache memory, for local storage of operating data or instructions.

The memory 706 can include volatile memory, non-volatile memory, or a combination thereof. For example, the memory 706 can include volatile memory, such as one or more DRAM modules such as double data rate (DDR) synchronous dynamic random access memory (SDRAM), and non-volatile memory, such as a disk drive, a solid state drive, flash memory, Phase-Change Memory (PCM), or any form of non-volatile memory capable of persistent electronic information storage, such as in the absence of an active power supply. The memory 706 can include another type of device, or multiple devices, now existing or hereafter developed, capable of storing data or instructions for processing by the processor 702. The processor 702 can access or manipulate data in the memory 706 via the bus 704. Although shown as a single block in FIG. 7, the memory 706 can be implemented as multiple units. For example, a system 700 can include volatile memory, such as RAM, and persistent memory, such as a hard drive or other storage.

The memory 706 can include executable instructions 708, data, such as application data 710, an operating system 712, or a combination thereof, for immediate access by the processor 702. The executable instructions 708 can include, for example, one or more application programs, which can be loaded or copied, in whole or in part, from non-volatile memory to volatile memory to be executed by the processor 702. The executable instructions 708 can be organized into programmable modules or algorithms, functional programs, codes, code segments, or combinations thereof to perform various functions described herein. For example, the executable instructions 708 can include instructions executable by the processor 702 to cause the system 700 to automatically, in response to a command, generate an integrated circuit design and associated test results based on a design parameters data structure. The application data 710 can include, for example, user files, database catalogs or dictionaries, configuration information or functional programs, such as a web browser, a web server, a database server, or a combination thereof. The operating system 712 can be, for example, Microsoft Windows®, macOS®, or Linux®; an operating system for a small device, such as a smartphone or tablet device; or an operating system for a large device, such as a mainframe computer. The memory 706 can comprise one or more devices and can utilize one or more types of storage, such as solid state or magnetic storage.

The peripherals 714 can be coupled to the processor 702 via the bus 704. The peripherals 714 can be sensors or detectors, or devices containing any number of sensors or detectors, which can monitor the system 700 itself or the environment around the system 700. For example, a system 700 can contain a temperature sensor for measuring temperatures of components of the system 700, such as the processor 702. Other sensors or detectors can be used with the system 700, as can be contemplated. In some implementations, the power source 716 can be a battery, and the system 700 can operate independently of an external power distribution system. Any of the components of the system 700, such as the peripherals 714 or the power source 716, can communicate with the processor 702 via the bus 704.

The network communication interface 718 can also be coupled to the processor 702 via the bus 704. In some implementations, the network communication interface 718 can comprise one or more transceivers. The network communication interface 718 can, for example, provide a connection or link to a network, such as the network 606 shown in FIG. 6, via a network interface, which can be a wired network interface, such as Ethernet, or a wireless network interface. For example, the system 700 can communicate with other devices via the network communication interface 718 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 720 can include a display; a positional input device, such as a mouse, touchpad, touchscreen, or the like; a keyboard; or other suitable human or machine interface devices. The user interface 720 can be coupled to the processor 702 via the bus 704. Other interface devices that permit a user to program or otherwise use the system 700 can be provided in addition to or as an alternative to a display. In some implementations, the user interface 720 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 714. The operations of the processor 702 can be distributed across multiple clients or servers, which can be coupled directly or across a local area or other suitable type of network. The memory 706 can be distributed across multiple clients or servers, such as network-based memory or memory in multiple clients or servers performing the operations of clients or servers. Although depicted here as a single bus, the bus 704 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In a first aspect, the subject matter described in this specification can be embodied in integrated circuits that include a cache comprising: a databank with multiple entries configured to store respective cache lines; an array of cache tags associated with respective entries in the databank, wherein each cache tag includes an indication of which one of two or more subsets the respective entry is a member of; and a cache control circuitry configured to: receive a message that will cause a cache block replacement; responsive to the message, select a way of the cache by applying a replacement policy to entries of the cache from only a first subset of the two or more subsets; and responsive to the message, evict an entry of the cache in the first subset and in the selected way.

In the first aspect, the cache control circuitry may be configured to set a flag in a cache tag associated with a respective entry in the cache to indicate whether data stored in the respective entry is also stored by an inner cache. In the first aspect, the cache control circuitry may be configured to, responsive to the message, select the first subset from among the two or more subsets based on a prioritization of the two or more subsets. In the first aspect, the cache control circuitry may be configured to update counters for entries of the cache from only the first subset. In the first aspect, the counters for entries of the cache may be age counters that are incremented to perform an aging operation of the replacement policy. In the first aspect, the replacement policy may be a Re-reference Interval Prediction policy and the counters for entries may be respective re-reference prediction values for the entries. In the first aspect, the cache control circuitry may be configured to compare values of the counters for entries of the cache from the first subset; and break a tie between two entries from the first subset with a same counter value by selecting among ways with the tied entries using a round robin selection. In the first aspect, the cache control circuitry may be configured to compare values of the counters for entries of the cache from the first subset; and break a tie between two entries from the first subset with a same counter value by selecting among ways with the tied entries using a pseudo random selection. In the first aspect, the cache control circuitry may be configured to: responsive to the message, insert a new cache line in the entry of the cache in the first subset and in the selected way; select one of two or more subsets for the entry storing the new cache line; and store an indication that the entry storing the new cache line is a member of the selected subset. In the first aspect, the cache may be an L2 cache that is shared by multiple processor cores. In the first aspect, the cache may be an L3 cache that is shared by multiple processor cores.

In a second aspect, the subject matter described in this specification can be embodied in methods that include partitioning entries of a set in a cache into two or more subsets; receiving a message that will cause a cache block replacement; responsive to the message, selecting a way of the cache by applying a replacement policy to entries of the cache from only a first subset of the two or more subsets; and, responsive to the message, evicting an entry of the cache in the first subset and in the selected way.

In the second aspect, partitioning the entries may include setting respective flags associated with the entries in the cache that indicate whether data stored in a respective entry is also stored by an inner cache. In the second aspect, the methods may include, responsive to the message, selecting the first subset from among the two or more subsets based on a prioritization of the two or more subsets. In the second aspect, applying the replacement policy to entries of the cache from only the first subset may include updating counters for entries of the cache from only the first subset. In the second aspect, the counters for entries of the cache may be age counters that are incremented to perform an aging operation of the replacement policy. In the second aspect, the replacement policy may be a Re-reference Interval Prediction policy and the counters for entries may be respective re-reference prediction values for the entries. In the second aspect, selecting a way of the cache may include comparing values of the counters for entries of the cache from the first subset; and breaking a tie between two entries from the first subset with a same counter value by selecting among ways with the tied entries using a round robin selection. In the second aspect, selecting a way of the cache may include comparing values of the counters for entries of the cache from the first subset; and breaking a tie between two entries from the first subset with a same counter value by selecting among ways with the tied entries using a pseudo random selection. In the second aspect, the methods may include, responsive to the message, inserting a new cache line in the entry of the cache in the first subset and in the selected way; selecting one of two or more subsets for the entry storing the new cache line; and storing an indication that the entry storing the new cache line is a member of the selected subset.

In a third aspect, the subject matter described in this specification can be embodied in a non-transitory computer readable medium comprising a circuit representation that, when processed by a computer, is used to program or manufacture an integrated circuit including a cache comprising: a databank with multiple entries configured to store respective cache lines; an array of cache tags associated with respective entries in the databank, wherein each cache tag includes an indication of which one of two or more subsets the respective entry is a member of; and a cache control circuitry configured to: receive a message that will cause a cache block replacement; responsive to the message, select a way of the cache by applying a replacement policy to entries of the cache from only a first subset of the two or more subsets; and responsive to the message, evict an entry of the cache in the first subset and in the selected way.

In the third aspect, the cache control circuitry may be configured to set a flag in a cache tag associated with a respective entry in the cache to indicate whether data stored in the respective entry is also stored by an inner cache. In the third aspect, the cache control circuitry may be configured to, responsive to the message, select the first subset from among the two or more subsets based on a prioritization of the two or more subsets. In the third aspect, the cache control circuitry may be configured to update counters for entries of the cache from only the first subset. In the third aspect, the counters for entries of the cache may be age counters that are incremented to perform an aging operation of the replacement policy. In the third aspect, the replacement policy may be a Re-reference Interval Prediction policy and the counters for entries may be respective re-reference prediction values for the entries. In the third aspect, the cache control circuitry may be configured to compare values of the counters for entries of the cache from the first subset; and break a tie between two entries from the first subset with a same counter value by selecting among ways with the tied entries using a round robin selection. In the third aspect, the cache control circuitry may be configured to compare values of the counters for entries of the cache from the first subset; and break a tie between two entries from the first subset with a same counter value by selecting among ways with the tied entries using a pseudo random selection. In the third aspect, the cache control circuitry may be configured to: responsive to the message, insert a new cache line in the entry of the cache in the first subset and in the selected way; select one of two or more subsets for the entry storing the new cache line; and store an indication that the entry storing the new cache line is a member of the selected subset. In the third aspect, the cache may be an L2 cache that is shared by multiple processor cores. In the third aspect, the cache may be an L3 cache that is shared by multiple processor cores.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An integrated circuit comprising:
a cache comprising:
a databank with multiple entries configured to store respective cache lines;
an array of cache tags associated with respective entries in the databank, wherein each cache tag includes an indication of which one of two or more subsets the respective entry is a member of; and
a cache control circuitry configured to:
receive a message that will cause a cache block replacement;
responsive to the message, select a way of the cache by applying a replacement policy to entries of the cache from only a first subset of the two or more subsets; and
responsive to the message, evict an entry of the cache in the first subset and in the selected way.

2. The integrated circuit of claim 1, in which the cache control circuitry is configured to:
set a flag in a cache tag associated with a respective entry in the cache to indicate whether data stored in the respective entry is also stored by an inner cache.

3. The integrated circuit of claim 1, in which the cache control circuitry is configured to:
responsive to the message, select the first subset from among the two or more subsets based on a prioritization of the two or more subsets.

4. The integrated circuit of claim 1, in which the cache control circuitry is configured to:
update counters for entries of the cache from only the first subset.

5. The integrated circuit of claim 4, wherein the counters for entries of the cache are age counters that are incremented to perform an aging operation of the replacement policy.

6. The integrated circuit of claim 4, wherein the replacement policy is a Re-reference Interval Prediction policy and the counters for entries are respective re-reference prediction values for the entries.

7. The integrated circuit of claim 1, in which the cache control circuitry is configured to:
responsive to the message, insert a new cache line in the entry of the cache in the first subset and in the selected way;
select one of two or more subsets for the entry storing the new cache line; and
store an indication that the entry storing the new cache line is a member of the selected subset.

8. The integrated circuit of claim 1, in which the cache is an L2 cache that is shared by multiple processor cores.

9. The integrated circuit of claim 1, in which the cache is an L3 cache that is shared by multiple processor cores.

10. A method, comprising:
partitioning entries of a set in a cache into two or more subsets;
receiving a message that will cause a cache block replacement;
responsive to the message, selecting a way of the cache by applying a replacement policy to entries of the cache from only a first subset of the two or more subsets; and
responsive to the message, evicting an entry of the cache in the first subset and in the selected way.

11. The method of claim 10, in which partitioning the entries comprises:
setting respective flags associated with the entries in the cache that indicate whether data stored in a respective entry is also stored by an inner cache.

12. The method of claim 10, comprising:
responsive to the message, selecting the first subset from among the two or more subsets based on a prioritization of the two or more subsets.

13. The method of claim 10, in which applying the replacement policy to entries of the cache from only the first subset comprises:
updating counters for entries of the cache from only the first subset.

14. The method of claim 13, wherein the counters for entries of the cache are age counters that are incremented to perform an aging operation of the replacement policy.

15. The method of claim 13, wherein the replacement policy is a Re-reference Interval Prediction policy and the counters for entries are respective re-reference prediction values for the entries.

16. The method of claim 13, wherein selecting a way of the cache comprises:
comparing values of the counters for entries of the cache from the first subset; and
breaking a tie between two entries from the first subset with a same counter value by selecting among ways with the tied entries using a round robin selection.

17. The method of claim 13, wherein selecting a way of the cache comprises:
comparing values of the counters for entries of the cache from the first subset; and
breaking a tie between two entries from the first subset with a same counter value by selecting among ways with the tied entries using a pseudo random selection.

18. The method of claim 10, comprising:
responsive to the message, inserting a new cache line in the entry of the cache in the first subset and in the selected way;
selecting one of two or more subsets for the entry storing the new cache line; and
storing an indication that the entry storing the new cache line is a member of the selected subset.

19. A non-transitory computer readable medium comprising a circuit representation that, when processed by a computer, is used to program or manufacture an integrated circuit comprising:
a cache comprising:
a databank with multiple entries configured to store respective cache lines;
an array of cache tags associated with respective entries in the databank, wherein each cache tag includes an indication of which one of two or more subsets the respective entry is a member of; and
a cache control circuitry configured to:
receive a message that will cause a cache block replacement;
responsive to the message, select a way of the cache by applying a replacement policy to entries of the cache from only a first subset of the two or more subsets; and
responsive to the message, evict an entry of the cache in the first subset and in the selected way.

20. The non-transitory computer readable medium of claim 19, in which the cache control circuitry is configured to:
update counters for entries of the cache from only the first subset.
